(19) United States
(12) Patent Application Publication
(10) Pub. No.: US 2014/0166540 A1
(43) Pub. Date: Jun. 19, 2014

(54) RESIDUE HYDROTREATMENT CATALYST COMPRISING VANADIUM, AND ITS USE IN A RESIDUE HYDROCONVERSION PROCESS

(71) Applicant: IFP Energies nouvelles, Rueil-Malmaison Cedex (FR)

(72) Inventors: Bertrand GUICHARD, Izeaux (FR); Mathieu DIGNE, Lyon (FR)

(73) Assignee: IFP ENERGIES NOUVELLES, Rueil-Malmaison Cedex (FR)

(21) Appl. No.: 14/105,211

(22) Filed: Dec. 13, 2013

(30) Foreign Application Priority Data
Dec. 18, 2012 (FR) 12/03467

(51) Int. Cl. B01J 27/199; C10G 65/04

(52) U.S. Cl. CPC B01J 27/199; C10G 65/04
USPC 208/211; 502/209

(57) ABSTRACT

A catalyst containing a group VIB element; a group VIII element; phosphorus in a quantity of 0.1% to 9% by weight of phosphorus pentoxide with respect to the total catalyst mass; vanadium in a quantity of 0.25% to 7% by weight of vanadium pentoxide with respect to the total catalyst mass; a porous refractory oxide support;

which catalyst has:
a total pore volume of 0.3 mL/g or more;
a macropore volume of 40% or less of the total pore volume;
a median diameter of the mesopores in the range 5 nm to 36 nm;
a BET surface area of at least 120 m²/g,
and a process for the hydrotreatment of heavy residue type hydrocarbon feeds, in a fixed bed and/or ebullated bed, by said catalyst.

### FIELD OF THE INVENTION

The invention relates to the hydrotreatment of heavy feeds, in particular of the residue type, and to hydrotreatment catalysts containing vanadium. The invention consists in using catalysts supported on an alumina type support, comprising an element from group VIB and an element from group VIII, as well as phosphorus and vanadium. It has been discovered that in various configurations of residue hydrotreatment processes, this type of catalyst can improve the degree of conversion of heavy fractions, in particular of the vacuum residue type, into a lighter fraction, while maintaining the other functions of the catalyst (hydrodesulphurization HDS, hydrodemetallization HDM, Conradson Carbon Residue reduction HDCCR, etc.) at high levels of performance.

### PRIOR ART

The purification and conversion of hydrocarbon feeds such as sulphur-containing oil cuts is becoming more and more important in refining with the increasing need to reduce the quantity of sulphur in oil cuts and to convert heavy fractions (with a boiling point of more than 370° C.) into lighter fractions which can be upgraded as fuel. In view of the specifications imposed by each country for commercial fuels, it is in fact necessary to upgrade imported crudes, which are becoming more and more rich in heavy fractions and in heteroatoms and ever more depleted in hydrogen, as much as possible.

A number of refining layouts involving different types of processes exist for the treatment of heavy oil feeds. Zong et al. (Recent Patents on Chemical Engineering, 2009, 2, 22-36) summarized the various known processes in this field. Of these, two principal catalytic processes for the hydrotreatment of atmospheric residues (AR) or vacuum residues (VR) exist commercially:
fixed bed processes;
ebullated bed processes.

The skilled person is aware that, because it brings a hydrocarbon feed into contact with a catalyst with properties, in terms of the metals of the active phase and porosity, which have been properly adjusted, catalytic hydrotreatment can be used to substantially reduce the quantity of its asphaltenes, metals, sulphur and other impurities while improving the hydrogen/carbon ratio (H/C) and also transforming it to a greater or lesser extent into lighter cuts.

Fixed bed residue hydrotreatment processes (usually known as “Residue desulphurization” unit or RDS) result in high refining performances: typically, they can be used to produce a cut with a boiling point of more than 370° C. containing less than 0.5% by weight of sulphur and less than 20 ppm of metals from feeds containing up to 5% by weight of sulphur and up to 250 ppm of metals (in particular nickel and vanadium: Ni+V). The various effluents obtained thereby can be used as a base for the production of good quality heavy fuels and/or pre-treated feeds for other units such as catalytic cracking units (fluid catalytic cracking). In contrast, residue hydroconversion into lighter cuts than the atmospheric residue (in particular gas oil and gasoline) is generally low, typically of the order of 10-20% by weight. In such a process, the feed, which has been mixed with hydrogen, moves through a plurality of fixed bed reactors disposed in series and filled with catalysts. The total pressure is typically in the range 100 to 200 bars and the temperatures are in the range 340° C. to 420° C. The effluents withdrawn from the last reactor are sent to a fractionation section.

RDS units suffer from at least one major disadvantage: the cycle times (period beyond which the performances of the unit cannot be maintained due to plugging and/or deactivation of the catalysts) are relatively short compared with processes for the hydrotreatment of lighter cuts: this results in stoppages to the unit and replacement of all or a portion of the spent catalysts with fresh catalysts. There are a number of reasons for this. Firstly, the metals naturally present in the feed, in particular in crude oil to a greater or lesser extent depending on the origin of the oil, have a tendency to become concentrated in the high boiling point fractions during distillation operations (in particular in the residues). This is particularly the case for vanadium, nickel, iron, sodium, titanium, silicon and copper. These metals, generally present in the form of organometallic complexes, are deposited in the form of a solid sulphide which will become attached to the inner surface of the pores of the catalyst. Coke can be deposited in addition to these metallic impurities: all of this then tends to deactivate and rapidly plug the catalytic system. The mouths of the pores become obstructed more swiftly than the other portions, which goes hand in hand with a reduction in their diameter. This increases the limitations on the diffusion of molecules and accentuates the concentration gradient from the periphery to the interior of the pores, to the point where the deposition of coke quite quickly results in complete obstruction of the pores. It is known that the first catalytic beds can rapidly become deactivated due to the large deposits of metals which occur. To compensate for this deactivation, the temperature then has to be increased. However, this increase in temperature encourages the deposition of coke, accelerating the intragranular plugging process (clogging of the pores of the catalyst) and intragranular plugging process (clogging of the catalytic bed). These deactivation phenomena have been well documented in the literature (A. Marafi et al. in Energy & Fuels 2008, 22, page 2925, M. Absi-Halabi et al. Applied Catalysis, 1991, 72, page 193, and B. M. Vogelaar in Chemical Engineering Science, 2006, 61, page 7463). These phenomena lead to stoppages in order to replace the solids and in overconsumption of catalyst, which is prejudicial to the process.

One way of improving the cycle time and of reducing the consumption of catalyst is to use a pre-treatment or a specific device upstream of the RDS unit to improve the overall performance of the unit. To this end, U.S. Pat. No. 5,472,928 can be cited, which proposes a reactor with a moving bed at the head of the unit, allowing for continuous addition and withdrawal of catalysts into and from the reactor. Similarly, U.S. Pat. No. 6,554,994 proposes using a reactor with an upward direction of flow (as opposed to a downflow in conventional RDS units) at the head of the unit with two layers of catalysts with different activities. Finally, patent FR 2 681 891 proposes a system of switchable reactors at the inlet to the RDS unit which, in a cyclic manner and in turn, can be short-circuited and recharged with fresh catalyst.

Apart from these improvements to the process, the development of high performance catalysts is vital. Conventionally, the fixed bed hydrotreatment process is constituted by at least two steps (or sections). The first step, termed hydrodemetallization (HDM), is principally aimed at eliminating the majority of the metals from the feed using one or more hydrodemetallization catalysts. The denomination HDM principally covers the operations of elimination of vanadium and nickel and, to a lesser extent, iron. The second step or section, termed hydrodesulphurization (HDS), consists of passing the product from the first step over one or more hydrodesulphurization catalysts, which are more active in terms of hydrodesulphurization and hydrogenation of the feed, but are less tolerant of metals.

For the hydrodemetallization step (HDM), the catalyst must be capable of processing feeds which are rich in metals and asphaltenes, while having a high demetallization capability associated with a high metals retention capacity and high coking resistance. Catalysts with a bimodal pore distribution which can be used to reach high HDM yields have been described in U.S. Pat. No. 5,221,656. The advantage of such a pore distribution is also emphasized in U.S. Pat. No. 5,089,463 and U.S. Pat. No. 7,119,045. The initial active phase of the catalyst placed in the hydrodemetallization step is generally constituted by nickel and molybdenum, and possibly dopants such as phosphorus. This active phase is known to be more hydrogenating than a phase constituted by cobalt and molybdenum, which is also occasionally used, and thus can be used to limit the formation of coke in the pores and thereby causing deactivation.

For the hydrodesulphurization (HDS) step, the catalyst has to have a high hydrogenolyzing potential so that it can carry out intense refining of the products: desulphurization, continued demetallization, reduction of the Conradson carbon residue (CCR, Conradson carbon residue, ASTM standard D 482, which can be used to evaluate the quantity of carbon residues produced after combustion under standard temperature and pressure conditions) and the asphaltenes content. Such a catalyst is characterized by a low macropore volume (U.S. Pat. No. 6,589,908). In addition, U.S. Pat. No. 4,818,743 discloses that the pore distribution may be monopopulated between 1 and 13 nm or bipopulated, with a relative difference between the two populations which may vary from 1 to 20 nm, as in U.S. Pat. No. 6,589,908. The initial active phase of the catalyst located in the hydrodesulphurization step is generally constituted by cobalt and molybdenum, as described in U.S. Pat. No. 6,332,976.

The prior art shows that it is of primordial importance to use a succession of catalysts with a different porosity between the HDM section and the HDS section. In fact, the dispersion of the active phase necessitates providing supports with high specific surface areas, but the pores of the support must also allow the reagents to diffuse readily within it. Thus, a compromise has to be reached between accessibility of the active phase and the pore size, as disclosed, for example, in patent US 2006/0060509. Catalysts based on cobalt, molybdenum and optionally phosphorus on mesoporous monomodal supports are preferred for the HDS step because they can be used to obtain better HDS conversions. The concatenation of these formulations on the supports defined hereinabove necessitates relatively large quantities of active phase (2% to 8% by weight of MoO₃, for the HDM section and 10% to 17% by weight of MoO₃ for the HDS section), thus increasing the cost of the catalysts.

When the quantity of metals in the feed is too high (more than 250 ppm) and/or when a high conversion (transformation of the heavy 540° C.+ (or 370° C.+) fraction into a lighter 540° C.− fraction (or 370° C.− fraction) is desired, ebullated bed hydrotreatment processes are preferred. In this type of process (M. S. Rana et al., Fuel 86 (2007), p. 1216), the purification performances are lower than those of RDS processes (typically the total hydrodesulphurization yield is in the range 55% to 92% and the total hydrodemetallization yield is in the range 65% to 95%). In contrast, hydroconversion of the residue fraction is high (of the order of 45% to 85% by volume). The high temperatures employed, in the range 415° C. to 440° C., contribute to this high hydroconversion. Thermal cracking reactions are in fact favoured, since the catalyst does not in general have a specific hydroconversion function. In addition, the effluents formed by this type of conversion may exhibit stability problems (sediment formation).

Thus, there is a need for the development of catalysts with a high hydroconversion function while maintaining high purification functions (hydrodemetallization and hydrodesulphurization in particular), such catalysts being able to be used in fixed bed or ebullated bed mode. In particular, to be more specific, one of the desired objectives is to contribute to improving the performances of RDS processes.

Adding a dopant can supply acidity in order to improve the hydroconversion of residues has been envisaged a number of times in the literature, but this has often been shown to suffer from a large number of technical problems which could not be overcome. Thus, when aluminosilicate type oxide supports are used, the textural properties are often limiting for the conversion of heavy oil products such as residues (Maity et al., Appl. Catal., A, 250 (2003), p. 231). Patents JP7196308 and JP9255321, which describe silica-aluminas and their textural properties, confirm that conventional silica-alumina supports are more suitable for the hydroconversion of lighter feeds compared with oil residues. Thus, in the end, the performances are disappointing (Rana et al., Pet. Sci. Technol., 25 (2007) p 187). The acidity also often causes the formation of excess coke (Maity et al., Energy & Fuels, 19 (2005), p 343).

In general, adding silicon in the hydrotreatment of residues is thus not envisaged for improving conversion, but as a doping agent modifying the active phase (CN1020109138) or to adjust the pore texture (EP 1 305 112 B1).

Other dopants envisaged for modifying the acidity of residue hydrotreatment catalysts do not modify hydroconversion performances under fixed bed conditions. Thus, the advantage of iron could only be observed under ebullated bed conditions (450° C., U.S. Pat. No. 4,729,980) or was not looked at from the point of view of the conversion generated (U.S. Pat. No. 2,817,626). Fluorine was also not shown to have an effect on conversion (CN 1887420).

Finally, vanadium, which is naturally present in oil products, has often been viewed as a poison which leads to catalyst deactivation. Thus, recourse has been made to catalysts prepared from a support co-mixed with spent, regenerated catalyst such as in patent JP2006-061845. The principal advantage of this preparation mode is to recycle spent catalyst and thus to provide economic savings. Co-mixing vanadium with the support was also envisaged in order to prevent the formation of nickel aluminate (U.S. Pat. No. 3,824,180 or U.S. Pat. No. 3,884,798), but no hydroconversion advantage was obtained.

Methods exist for preparing aqueous solutions containing vanadium and molybdenum and optionally phosphorus (U.S. Pat. No. 5,792,721). The use of molybdenum-vanadium mixtures in the form of heteropolyanions to prepare catalysts has been described for hydrotreatment (Soogund et al., Appl. Catal. B, 98 (2010), p 39), or for oxidative desulphurization (EP 0 482 841).

However, no gain in hydroconversion associated with the joint use of molybdenum and vanadium has been described. Further, none of the patents proposing incorporating vanadium into catalysts (for example patents FR 2 780 302, U.S. Pat. No. 3,269,958, U.S. Pat. No. 2,817,626, U.S. Pat. No. 4,499,203, or U.S. Pat. No. 3,849,292) has been able to demonstrate any advantage in hydroconversion. In particular, the advantage of nickel-vanadium formulation has been shown only for hydrodemetallization (U.S. Pat. No. 3,920,538). The molybdenum-vanadium formulation (U.S. Pat. No. 4,440,631) per se is not the most advantageous under severe hydroconversion conditions (450° C.), in particular with a large quantity of sediments which are formed.

The Applicant has discovered that the use, in residue hydrotreatment, of a catalyst associating an element from group VIB, such as molybdenum, an element from group VIII such as cobalt or nickel, as well as phosphorus and vanadium, these elements being supported on a refractory alumina type oxide, bring about a gain in hydroconversion which could not be expected by the skilled person.

### AIM OF THE INVENTION

The present invention concerns a catalyst for the hydrotreatment of heavy hydrocarbon feeds, comprising at least one element from group VIB and at least one element from group VIII supported on a refractory oxide support, for example alumina. The catalyst used in the process of the invention contains vanadium and phosphorus, the vanadium being impregnated with all or a portion of the other metallic elements on the refractory oxide support.

The invention also concerns a process for the hydrotreatment of heavy hydrocarbon feeds using said catalyst. The catalyst may be used directly on the heavy hydrocarbon feed to be treated, or in association with one or more other catalysts which are known to the skilled person. Introducing it brings about a significant gain in hydroconversion, i.e. an increase in the transformation of at least a fraction of the heavy feed into lighter hydrocarbons.

### SUMMARY OF THE INVENTION

The invention concerns a catalyst for the hydrotreatment of heavy hydrocarbon feeds, comprising:
at least one element from group VIB;
at least one element from group VIII;
phosphorus in a quantity in the range 0.1% to 9% by weight of phosphorus pentoxide with respect to the total catalyst mass;
vanadium in a quantity in the range 0.25% to 7% by weight of vanadium pentoxide with respect to the total catalyst mass;
at least one porous refractory oxide support;
   said catalyst having the following characteristics:
   a total pore volume of 0.3 mL/g or more;
   a macropore volume, defined as the volume of pores with a diameter of more than 50 nm, of 40% or less of the total pore volume;
   a median diameter of the mesopores, defined as pores with a diameter in the range 3.6 to 50 nm, in the range 5 nm to 36 nm;
   a BET surface area of at least 120 m²/g.

The vanadium content is advantageously in the range 0.5% to 5% by weight of vanadium pentoxide with respect to the total catalyst mass, preferably in the range 0.6% to 4% by weight of vanadium pentoxide with respect to the total catalyst mass.

The quantity of metal from group VIB is advantageously in the range 2% to 20% by weight and the quantity of metal from group VIII is advantageously in the range 0.1% to 5% by weight, the contents being expressed as the % of metallic oxide with respect to the total catalyst mass.

The oxide support advantageously comprises a major proportion of alumina.

Preferably, the element from group VIB is molybdenum.

Preferably, the element from group VIII is nickel or cobalt.

The atomic ratio of vanadium to metals from group VIB is advantageously in the range 0.1:1 to 0.5:1.

The catalyst may be in the partially or completely sulphurized form.

In one embodiment, the median diameter of the mesopores is in the range 5 to 20 nm, the total pore volume is 0.3 mL/g or more and the macropore volume is less than 10% of the total pore volume.

In another embodiment, the median diameter of the mesopores is in the range 10 to 36 nm, the total pore volume is 0.5 mL/g or more and the macropore volume is more than 5% of the total pore volume.

The invention also concerns a hydrotreatment process using at least one catalyst as described hereinabove for the hydrotreatment of heavy hydrocarbon feeds selected from atmospheric residues, vacuum residues obtained from straight run distillation, deasphalted oils, residues obtained from conversion processes such as, for example, those obtained from coking, from fixed bed hydroconversion, from ebullated bed hydroconversion or from moving bed hydroconversion, used alone or as a mixture.

The process may be carried out in part in an ebullated bed at a temperature in the range 320° C. to 450° C., at a partial pressure of hydrogen in the range 3 MPa to 30 MPa, at a space velocity which is advantageously in the range 0.1 to 10 volumes of feed per volume of catalyst per hour, and with a ratio of gaseous hydrogen to liquid hydrocarbon feed which is advantageously in the range 100 to 3000 normal cubic metres per cubic metre.

The process may be carried out at least in part in a fixed bed at a temperature in the range 320° C. to 450° C., at a partial pressure of hydrogen in the range 3 MPa to 30 MPa, at a space velocity which is advantageously in the range 0.05 to 5 volumes of feed per volume of catalyst per hour, and with a ratio of gaseous hydrogen to liquid hydrocarbon feed which is in the range 200 to 5000 normal cubic metres per cubic metre.

Advantageously, the fixed bed residue hydrotreatment process comprises at least:
a) a hydrodemetallization step;
b) a hydrodesulphurization step;
said catalyst being used in at least one of said steps a) and b).

### DETAILED DESCRIPTION OF THE INVENTION

The Applicant has discovered that by combining vanadium and phosphorus with at least one metallic element from group VIB and at least one metallic element from group VIII, all supported on a porous refractory oxide having suitable textural characteristics, an improved catalyst is obtained for the hydrotreatment of heavy hydrocarbon feeds. Said catalyst when it is loaded into at least a portion of the reactor or reactors of a process for the hydrotreatment of heavy hydrocarbon fractions (functioning at least in part in a fixed bed), said catalyst can be used to improve the performances of the complete catalytic system, and in particular the degree of hydroconversion. By using said catalyst of the invention, none of the disadvantages listed in the prior art arise, and thus a process which is of great interest to the refiner is provided.

The term “hydroconversion” as used hereinabove makes reference to the degree of conversion measured between the incoming feed and an effluent from a hydrotreatment process with respect to a reference temperature. As an example, the term “hydroconversion of the 540° C.+ cut” is used to define the degree of conversion of fractions of the feed with a boiling point of more than 540° C. into lighter fractions with a boiling point of less than 540° C.

### Description of the Catalyst

The catalyst of the invention comprises at least one metal from group VIB, at least one metal from group VIII, phosphorus, vanadium and a support constituted by a porous refractory oxide and can advantageously be used in a process for the hydrotreatment of heavy feeds such as oil residues.

The metals from group VIB are advantageously selected from molybdenum and tungsten; preferably, said metal from group VIB is molybdenum.

The metals from group VIII are advantageously selected from iron, nickel and cobalt; nickel or cobalt is preferred.

The active phase of the catalyst also comprises phosphorus and vanadium.

The catalyst used in accordance with the present invention may advantageously be obtained using any of the methods known to the skilled person.

The catalyst support used is constituted by extrudates with a diameter which is generally in the range 0.5 to 10 mm, preferably 0.8 to 3.2 mm.

The support constituted by a porous refractory oxide generally comprises a major proportion of alumina, i.e. at least 50% alumina. It is advantageously selected from matrices with a high alumina component such as, for example, alumina or silica-alumina.

Dopants may be introduced into the support. These include silica, titanium or zirconia.

When the matrix contains silica, the quantity of silica is preferably 25% by weight or less with respect to the total weight of the alumina matrix. Preferably, the support is alumina, more preferably gamma alumina.

The support is generally pre-shaped and calcined before impregnation. Shaping may advantageously be carried out by extrusion, by pelletization, using the oil drop method, by rotary plate granulation or using any other method which is well known to the skilled person. The calcining may advantageously be carried out between 450° C. and 1000° C. in dry or moist air.

The catalyst of the invention advantageously has a total pore volume (TPV) of at least 0.3 mL/g, preferably at least 0.4 mL/g.

In the case in which the catalyst is used in a hydrodemetallization section HDM, the total pore volume is advantageously at least 0.5 mL/g, preferably at least 0.6 mL/g, more preferably at least 0.65 mL/g.

In the case in which the catalyst is used in a hydrodesulphurization section HDS, the total pore volume is advantageously at least 0.3 mL/g, preferably at least 0.4 mL/g.

The total pore volume is determined using the mercury intrusion method. The volumes are measured using the mercury penetration technique in which Washburn's equation is applied, which gives the relationship between the pressure, the diameter of the smallest pore into which the mercury can penetrate at said pressure, the wetting angle and the surface tension in accordance with the formula:

$$d = \frac{( 4. t . cos ( θ ) ) .10}{P}$$

in which
“d” represents the pore diameter (nm);
t the surface tension (48.5 Pa);
θ the contact angle (θ=140°); and
P the pressure (MPa).

The catalyst used in the invention advantageously has a macropore volume V_{50 nm}, defined as the volume of pores with a diameter of more than 50 nm, in the range 0 to 40% of the total pore volume, preferably in the range 0 to 30% of the total pore volume.

In the case in which the catalyst is used in a HDM section, the macropore volume is advantageously more than 5%, preferably more than 10% and more preferably more than 20% of the total pore volume (TPV). Such a characteristic may advantageously be obtained by a multimodal distribution or from a bimodal distribution support, the first mode being mesoporous and the second, macroporous.

In the case in which the catalyst is used in a HDS section, the macropore volume is less than 10%, preferably 5%, and more preferably 1% of the total pore volume (TPV).

The diameter at Vmeso/2 (median mesopore diameter, denoted pd_{Vmeso/2}), the mesopore volume being the volume corresponding to pores with a diameter of less than 50 nm, is advantageously in the range 5 nm to 36 nm, preferably in the range 6 to 25 nm.

In the case in which the catalyst is used in a HDM section, the median mesopore diameter is advantageously in the range 10 to 36 nm, preferably in the range 10 to 25 nm.

In the case in which the catalyst is used in a HDS section, the median mesopore diameter is advantageously in the range 5 nm to 20 nm, preferably in the range 6 to 15 nm.

The catalyst used in the present invention advantageously has a BET specific surface area (S_{BET}) of at least 120 m²/g, preferably at least 150 m²/g. The term “BET surface area” means the specific surface area determined by nitrogen adsorption using ASTM standard D 3663-78 established from the BRUNAUER-EMMET-TELLER method described in the periodical “The Journal of the American Chemical Society”, 60, 309 (1938).

Before shaping the support extrudates, all or a portion of the catalytic metals or a precursor compound of the catalytic metals of the final catalyst may optionally be introduced using any known method and at any stage of the preparation, preferably by impregnation or co-mixing. If all or a portion of the catalytic elements has not been introduced during synthesis of the support, then the support then undergoes at least one impregnation step. The conventional impregnation which is carried out is that termed “dry” impregnation and is well known to the skilled person, but any other mode of impregnation which is known to the skilled person may be used. It may be carried out in a single step using a solution containing all of the constituent elements of the final catalyst, i.e. a solution containing at least one vanadium compound, at least one phosphorus compound, at least one compound of at least one metal from group VIB and optionally at least one compound of at least one metal from group VIII.

Impregnation may also be carried out in at least two steps. The various elements may thus be impregnated in succession, or one of the elements may also be impregnated in multiple sequences. One of the impregnation steps which is carried out may in particular make use of an organic compound which the skilled person wishes to introduce in addition to the constituent elements of the final catalyst.

The solution of the constituent compounds of the elements of the final catalyst may advantageously be prepared in an aqueous solvent, but also in a water-organic solvent mixture or in a pure organic solvent. Ethanol or toluene may thus be cited as examples of an organic solvent. The pH of this solution may be modified by optional addition of an acid. Finally, hydrogen peroxide may optionally be added in order to modify the species in solution and/or to aid solubility of the precursors. The skilled person will draw upon experience and knowledge for this purpose.

The present invention is also applicable to the case in which the catalyst used has not been calcined. In this case, after impregnation, the catalyst is advantageously merely dried, i.e. the final heat treatment which is undertaken is not more than 300° C.

Advantageous precursors which may be introduced into the solution as a source of elements from group VIII are: citrates, oxalates, carbonates, hydroxycarbonates, hydroxides, phosphates, sulphates, aluminates, molybdates, tungstates, oxides, nitrates, halides, for example chlorides, fluorides or bromides, acetates, or any other mixture of the precursors cited here. Advantageous sources of the element from group VI which are well known to the skilled person include, for molybdenum and tungsten for example: oxides, hydroxides, molybdic and tungstic acids and their salts, in particular ammonium salts, ammonium heptamolybdate, ammonium tungstate, phosphomolybdic acid, phosphotungstic acid, and their salts. Preferably, oxides or ammonium salts are used, such as ammonium molybdate, ammonium heptamolybdate or ammonium tungstate.

The preferred phosphorus source is orthophosphoric acid, but its salts and esters such as alkali phosphates, ammonium phosphate, gallium phosphate or alkyl phosphates are also suitable. Phosphorous acids for example hypophosphorous acid, phosphomolybdic acid and its salts, or phosphotungstic acid and its salts, may advantageously be employed.

The source of vanadium which is advantageously used may be selected from vanadium pentoxide, vanadium acetyl acetonate, vanadium sulphate and vanadium oxalate.

An organic molecule with chelating properties as regards the metals may advantageously be introduced into the solution if the skilled person adjudges it necessary. The product is then generally matured, dried and optionally calcined in an oxidizing atmosphere, for example in air, usually at a temperature of approximately 300° C. to 600° C., preferably 350° C. to 550° C.

The quantity of metal or metals from group VIB is advantageously in the range 2% to 20% by weight of the trioxide of the metal or metals from group VIB with respect to the total catalyst mass, preferably in the range 3% to 17% by weight, highly preferably in the range 4% to 17% by weight. The sum of the quantities of metals from group VIII is advantageously in the range 0.1% to 5% by weight of the oxide of the metals from group VIII with respect to the total catalyst mass, preferably in the range 0.3% to 4%, more preferably in the range 0.6% to 3.5% by weight, still more preferably in the range 1% to 3.5% by weight.

The respective quantities of the metal or metals from group VIB and the metals from group VIII are advantageously such that the atomic ratio of metals from group VIII to metal or metals from group VIB (VIII/VIB) is in the range 0.1:1 to 0.7:1, preferably in the range 0.2:1 to 0.6:1 and more preferably 0.35:1 to 0.55:1. This ratio can in particular be adjusted as a function of the type of feed and the position of the catalyst, either in a HDM section or in a HDS section.

The phosphorus content is advantageously in the range 0.1% to 9% by weight of phosphorous pentoxide with respect to the total catalyst mass, preferably in the range 0.25% to 6% by weight and still more preferably in the range 0.5% to 4.5% by weight. The vanadium content is in the range 0.25% to 7% by weight of vanadium pentoxide with respect to the total catalyst mass, preferably in the range 0.5% to 5% by weight and still more preferably in the range 0.6% to 4% by weight.

In addition, the respective quantities of vanadium and metal or metals from group VIB are advantageously such that the atomic ratio of vanadium to metals from group VIB is advantageously in the range 0.1:1 to 0.5:1, preferably in the range 0.2:1 to 0.4:1 and more preferably in the range 0.2:1 to 0.35:1.

### Sulphurization of Catalyst

Before using them in the process of the invention, the catalysts of the present invention undergo a sulphurization treatment in order to transform at least a portion of the metallic species thereof into the sulphide before bringing them into contact with the feed to be processed. This treatment for activation by sulphurization is well known to the skilled person and may be carried out using any method which is already known which has been described in the literature, for example: ex situ or in situ sulphurization, or unconventional sulphurization processes. One conventional sulphurization method which is well known to the skilled person consists of heating the mixture of solids in a stream formed by a mixture of hydrogen and hydrogen sulphide or in a stream formed by a mixture of hydrogen and hydrocarbons containing sulphur-containing molecules at a temperature in the range 150° C. to 800° C., preferably in the range 250° C. to 600° C., generally in a flushed bed reaction zone.

### Process for the Hydrotreatment of Heavy Hydrocarbon Feeds

### Feeds

The feeds treated in the process of the invention are advantageously selected from atmospheric residues, straight run distillation vacuum residues, crude oils which may or may not have been topped, deasphalted oils, residues from conversion processes such as, for example those derived from coking, from fixed bed hydroconversion, from ebullated bed hydroconversion, or indeed from moving bed hydroconversion, used alone or as a mixture. These feeds may advantageously be used as is or indeed diluted by a hydrocarbon fraction or a mixture of hydrocarbon fractions which may be selected from products obtained from the FCC process, a light cycle oil (LCO), a heavy cycle oil (HCO), a decanted oil (DO), a slurry, or derived from distillation, gas oil fractions, in particular those obtained by vacuum distillation known as VGO (vacuum gas oil) or recycled gas oil from a heavy feed hydrotreatment unit. Hence, the heavy feeds may advantageously comprise cuts obtained from the coal liquefaction process, aromatic extracts, or any other hydrocarbon cuts.

Said heavy feeds generally have more than 1% by weight of molecules with a boiling point of more than 500° C., a Ni+V metals content of more than 1 ppm by weight, preferably more than 20 ppm by weight, and an asphaltenes content, precipitated in heptane (NFT standard 60-115), of more than 0.05% by weight, preferably more than 1% by weight.

The heavy feeds may advantageously also be mixed with coal in the powder form; this mixture is generally known as slurry. These feeds may advantageously be by-products obtained from the conversion of coal and re-mixed with fresh coal. The quantity of coal in the heavy feed is generally and preferably a ratio of 1:4 (oil/coal) and may advantageously vary widely between 0.1 and 1. The coal may contain lignite, or may be a sub-bituminous coal or a bituminous coal. Any other type of coal is suitable for use in the invention, both in fixed bed reactors or in reactors operating in ebullated bed mode.

### Implementations of the Process

The process of the invention advantageously employs one or more of the catalysts described in the invention in hydrotreatment processes that can be used to convert hydrocarbon heavy feeds containing sulphur-containing impurities and metallic impurities. One aim of using the catalysts of the present invention concerns an improvement of performances, in particular in hydroconversion, compared with known prior art catalysts. The catalyst described can be used to improve any step (HDM or HDS) and preserve the HDM, HDS, HDCCR and possibly hydrodeasphalting functions compared with conventional catalysts, i.e. catalysts containing no vanadium other than that provided by the hydrodemetallization reaction. In the catalytic concatenation, all or a portion of the catalysts may comply with the description of the invention given hereinabove. In particular, it is possible to form a concatenation combining conventional catalysts with catalysts in accordance with the invention.

The process of the invention may be carried out at least in part in fixed bed mode with the aim of eliminating metals and sulphur and of reducing the mean boiling point of the hydrocarbons. In the case in which the process of the invention is carried out in a fixed bed, the operating temperature is advantageously in the range 320° C. to 450° C., preferably 350° C. to 410° C., at a partial pressure of hydrogen which is advantageously in the range 3 MPa to 30 MPa, preferably 10 to 20 MPa, at an hourly space velocity which is advantageously in the range 0.05 to 5 volumes of feed per volume of catalyst per hour, and with a ratio of gaseous hydrogen to liquid hydrocarbon feed which is advantageously in the range 200 to 5000 normal cubic metres per cubic metre, preferably 500 to 1500 normal cubic metres per cubic metre. The process generally comprises at least one hydrodemetallization step and at least one hydrodesulphurization step. Thus, the invention concerns hydrodemetallization and hydrodesulphurization steps; however, other transformation steps may advantageously be carried out, either upstream of the hydrodemetallization step or downstream of the hydrodesulphurization step or between the hydrodemetallization and hydrodesulphurization steps. The process of the invention is advantageously carried out in one to ten successive reactors, the catalyst or catalysts of the invention possibly advantageously being charged into one or more reactors and/or into all or a portion of the reactors.

The process of the invention may also be carried out in part in an ebullated bed on the same feeds. In the case in which the process of the invention is carried out in ebullated bed mode, the catalyst is advantageously used at a temperature in the range 320° C. to 450° C., at a partial pressure of hydrogen which is advantageously in the range 3 to 30 MPa, preferably in the range 10 to 20 MPa, at an hourly space velocity which is advantageously in the range 0.1 to 10 volumes of feed per volume of catalyst per hour, preferably in the range 0.5 to 2 volumes of feed per volume of catalyst per hour, and with a ratio of gaseous hydrogen to liquid hydrocarbon feed which is advantageously in the range 100 to 3000 normal cubic metres per cubic metre, preferably 200 to 1200 normal cubic metres per cubic metre.

In a preferred implementation, the process of the invention is carried out in fixed bed mode.

The following examples illustrate the invention without in any way limiting its scope.

### EXAMPLES

### Example 1

### Preparation of a Support A Forming Part of the Composition of the HDM Catalysts of the Invention

We prepared a support A based on alumina in order to be able to prepare catalysts as described in the examples below from the same shaped support. To this end, we initially prepared boehmite (or alumina gel) using the process described in patent U.S. Pat. No. 4,154,812. The reactor was heated to 65° C. Before the phase for simultaneous addition of the two reagents, approximately 8 g equivalent of Al₂O₃ was introduced into a volume of 1290 mL. During the phase for simultaneous addition of the two reagents, the pH was maintained at a value close to 9. When addition was complete, 144 g equivalent of Al₂O₃ was poured in to give a total volume of 3530 mL. The suspended boehmite obtained was filtered, washed to eliminate impurities and dried overnight at 120° C. This gel was then mixed with an aqueous solution containing 52.7% nitric acid (1% by weight acid per gram of dry gel) then mixed for 20 minutes in a Z arm mixer. The paste was then mixed with an aqueous solution containing 20.3% ammonia (40 mole % ammonia per mole of acid) for 5 minutes in the same mixer. At the end of this mixing step, the paste obtained was passed through a die with three-lobed orifices with an inscribed diameter of 2.0 mm using a piston extruder. The extrudates were then dried overnight at 120° C. and calcined at 750° C. for two hours in a flow of moist air containing 200 g of water/kg of dry air.

1.6 mm diameter three-lobed extrudates were thus obtained with a specific surface area of 180 m²/g, a total pore volume of 0.80 mL/g, a mesopore distribution centred on 15 nm (pd at Vmeso/2). This alumina A also contained 0.20 mL/g of the pore volume in pores with a diameter of more than 50 nm (macropore volume), i.e. a macropore volume equal to 25% of the total pore volume.

### Example 2

### Preparation of a Support B Forming Part of the Composition of the HDS Catalysts of the Invention

We prepared a support B based on alumina in order to be able to prepare catalysts as described in the examples below from the same shaped support. To this end, we initially prepared boehmite (or alumina gel) using the process described in patent U.S. Pat. No. 4,154,812. The reactor was heated to 60° C. Before the phase for simultaneous addition of the two reagents, approximately 24 g equivalent of Al₂O₃ was introduced into a volume of 1280 mL. During the phase for simultaneous addition of the two reagents, the pH was maintained at a value close to 9. When addition was complete, 124 g equivalent of Al₂O₃ was poured in to give a total volume of 3420 mL. The suspended boehmite obtained was filtered, washed to eliminate impurities and dried overnight at 120° C. This gel was then mixed with an aqueous solution containing 66% nitric acid (5% by weight acid per gram of dry gel) then mixed for 15 minutes in a Z arm mixer. The paste was then mixed with an aqueous solution containing 20.3% ammonia (40 mole % ammonia per mole of acid) for 5 minutes in the same mixer. At the end of this mixing step, the paste obtained was passed through a die with three-lobed orifices with an inscribed diameter of 1.6 mm using a piston extruder. The extrudates were then dried overnight at 120° C. and calcined at 540° C. for 2 hours in dry air. 1.2 mm diameter three-lobed extrudates were thus obtained with a specific surface area of 281 m²/g, a total pore volume of 0.71 mL/g and a monomodal pore distribution centred on 10 nm. Support B thus had a macropore volume equal to 0% of the total pore volume.

The textural characteristics of supports A and B are summarized in Table 1.

TABLE 1
Textural characteristics of supports used

| | A | B |
|---|---|---|
| S_{BET} (m2/g) | 180 | 281 |
| TPV (mL/g) | 0.80 | 0.69 |
| pd_{Vmeso/2} (nm) | 15 | 10 |
| V_{50 nm}(mL/g) | 0.2 | — |
| V_{50 nm} (% of TPV) | 25 | 0 |

### Example 3

### Preparation of a Catalyst A1 (Comparative)

We dry impregnated the bimodal support A obtained from Example 1 (characteristics in Table 1). The aqueous impregnation solution contained molybdenum and nickel salts as well as phosphoric acid (H₃PO₄) and hydrogen peroxide (H₂O₂). The molybdenum salt was ammonium heptamolybdate, Mo₇O₂₄(NH₄)₆.4H₂O and the nickel salt was nickel nitrate, Ni(NO₃)₂.6H₂O. The quantities of each of these salts in solution were determined so as to deposit the desired quantity of each element in the catalyst.

After maturing at ambient temperature in a water-saturated atmosphere, the extrudates of the impregnated support were dried overnight at 120° C. then calcined at 500° C. for 2 hours in air. The molybdenum trioxide content was 6% by weight, that for nickel oxide was 1.5% by weight, and that for phosphorous pentoxide was 1.2% by weight. The atomic ratio P/Mo was equal to 0.4 and the Ni/Mo atomic ratio was equal to 0.49.

### Example 4

### Preparation of a Catalyst A2 (In Accordance with the Invention)

We dry impregnated the support A obtained from Example 1 (characteristics in Table 1). The aqueous impregnation solution contained molybdenum, nickel and vanadium salts as well as phosphoric acid (H₃PO₄) and hydrogen peroxide (H₂O₂). The molybdenum salt was ammonium heptamolybdate, Mo₇O₂₄(NH₄)₆.4H₂O and that for nickel was nickel nitrate, Ni(NO₃)₂.6H₂O. The vanadium was introduced using vanadium sulphate. The quantities of each of these salts in solution were determined so as to deposit the desired quantity of each element in the catalyst.

After maturing at ambient temperature in a water-saturated atmosphere, the extrudates of the impregnated support were dried overnight at 120° C. then calcined at 500° C. for 2 hours in air. The molybdenum trioxide content was 6% by weight, that for nickel oxide was 1.5% by weight, that for vanadium pentoxide was equal to 0.9% by weight, and that for phosphorous pentoxide was 1.8% by weight. The atomic ratio P/Mo was equal to 0.62 and the atomic ratio Ni/Mo was equal to 0.49. Finally, the atomic ratio V/Mo was equal to 0.24.

### Example 5

### Preparation of a Catalyst A3 (In Accordance with the Invention)

We dry impregnated the bimodal support A obtained from Example 1 (characteristics in Table 1). The aqueous impregnation solution contained molybdenum, cobalt and vanadium salts as well as phosphoric acid (H₃PO₄) and hydrogen peroxide (H₂O₂). The molybdenum salt was ammonium heptamolybdate Mo₇O₂₄(NH₄)₆.4H₂O and the cobalt salt was cobalt nitrate Co(NO₃)₂.6H₂O. The vanadium was introduced using vanadium sulphate. The quantities of each of these salts in solution were determined so as to deposit the desired quantity of each element in the catalyst.

After maturing at ambient temperature in a water-saturated atmosphere, the extrudates of the impregnated support were dried overnight at 120° C. then calcined at 500° C. for 2 hours in air. The molybdenum trioxide content was 6% by weight, that for cobalt oxide was 1.5% by weight, that for vanadium pentoxide was equal to 0.9% by weight, and that for phosphorous pentoxide was 1.8% by weight. The atomic ratio P/Mo was equal to 0.61 and the atomic ratio Co/Mo was equal to 0.49. Finally, the atomic ratio V/Mo was equal to 0.24.

### Example 6

### Preparation of a Catalyst A4 (Comparative)

We dry impregnated the bimodal support A obtained from Example 1 (characteristics in Table 1). The aqueous impregnation solution contained molybdenum, nickel and vanadium salts as well as phosphoric acid (H₃PO₄) and hydrogen peroxide (H₂O₂). The molybdenum salt was ammonium heptamolybdate Mo₇O₂₄(NH₄)₆.4H₂O and the nickel salt was nickel nitrate Ni(NO₃)₂.6H₂O. The vanadium was introduced using vanadium sulphate. The quantities of each of these salts in solution were determined so as to deposit the desired quantity of each element in the catalyst.

After maturing at ambient temperature in a water-saturated atmosphere, the extrudates of the impregnated support were dried overnight at 120° C. then calcined at 500° C. for 2 hours in air. The molybdenum trioxide content was 6% by weight, that for nickel oxide was 1.5% by weight, that for vanadium pentoxide was equal to 0.21% by weight, and that for phosphorous pentoxide was 1.2% by weight. The atomic ratio P/Mo was equal to 0.4 and the Ni/Mo atomic ratio was equal to 0.49. Finally, the atomic ratio V/Mo was equal to 0.05.

### Example 7

### Evaluation of Catalysts A1, A2, A3 and A4 in the Hydrotreatment of Arabian Light Atmospheric Residues (AR)

Catalysts A1 and A2 underwent a catalytic test in a closed, continuously stirred batch reactor on an Arabian Light AR type feed (Table 2).

TABLE 2
Characteristics of AR Arabian Light feed used

| | | AR Arabian Light |
|---|---|---|
| Density 15/4 | | 0.9712 |
| Viscosity at 100° C. | mm²/s | 45 |
| Sulphur | % by wt | 3.38 |
| Nitrogen | ppm | 2257 |
| Nickel | ppm | 10.6 |
| Vanadium | ppm | 41.0 |
| Aromatic carbon | % | 24.8 |
| Conradson carbon residue | % by wt | 10.2 |
| C7 asphaltenes | % by wt | 3.2 |
| SARA | | |
| Saturates | % by wt | 28.1 |
| Aromatics | % by wt | 46.9 |
| Resins | % by wt | 20.1 |
| Asphaltenes | % by wt | 3.5 |
| Simulated distillation | | |
| IP | ° C. | 219 |
| 5% | ° C. | 299 |
| 10% | ° C. | 342 |
| 20% | ° C. | 409 |
| 30% | ° C. | 463 |
| 40% | ° C. | 520 |
| 50% | ° C. | 576 |
| 80% | ° C. | 614 |
| SD: distillation residue | % by wt | 57 |

To this end, after an ex situ sulphurization step by circulating a H₂S/H₂ gas mixture for 2 hours at 350° C., 15 mL of catalyst was charged in the absence of air into the batch reactor then covered with 90 mL of feed. The operating conditions are listed in Table 3.

TABLE 3
Operating conditions used in batch reactor

| | | |
|---|---|---|
| Total pressure | 9.5 | MPa |
| Test temperature | 370° | C. |
| Test duration | 3 | hours |

At the end of the test, the reactor was cooled and after stripping the atmosphere three times under nitrogen (10 minutes at 1 MPa), the test sample was recovered and analysed by X ray fluorescence (sulphur and metals) and by simulated distillation (ASTM D7169).

The HDS percentage is defined as follows:

HDS (% by wt)=((% by wt S)_{feed}−(% by wt S)ₛₐₘₚₗₑ)/(% by wt S)_{feed}×100

In the same manner, the percentage HDM is defined as follows:

HDM (% by wt)=((ppm by wt Ni+V)_{feed}−(ppm by wt Ni+V)ₛₐₘₚₗₑ)/(ppm by wt Ni+V)_{feed}×100

Finally, the measured hydroconversion is the degree of conversion of the 540° C.+ fraction defined by the following relationship:

HDX₅₄₀₊(% by wt)=((X₅₄₀₊)_{feed}−(X₅₄₀₊)_{efficient})/(X₅₄₀₊)_{feed}×100

where X₅₄₀₊ is the fraction by weight of compounds with a molecular weight of more than 540° C.

The performances of the catalysts are summarized in Table 4.

TABLE 4
HDS, HDM and HDX performances
of catalysts A1, A2, A3 and A4

| | HDS | HDM | HDX₅₄₀₊ |
|---|---|---|---|
| Catalysts | (% by wt) | (% by wt) | (% by wt) |
| A1 (comparative) | 52 | 77 | 12 |
| A2 (invention) | 46 | 76 | 19 |
| A3 (invention) | 45 | 73 | 20 |
| A4 (comparative) | 45 | 72 | 13 |

It can be deduced from Table 4 that using the catalysts of the present invention results in a substantial gain in VR conversion (540+ cut) with a relatively small degradation in HDS and HDM performances.

### Example 8

### Preparation of a Catalyst B1 (Comparative)

We dry impregnated a support B obtained from Example 2 for which there was no macroporosity; its characteristics are indicated in Table 1. The aqueous impregnation solution contained molybdenum and nickel salts as well as phosphoric acid (H₃PO₄) and hydrogen peroxide (H₂O₂). The molybdenum salt was ammonium heptamolybdate, Mo₇O₂₄(NH₄)₆.4H₂O and the nickel salt was nickel (cobalt) nitrate, Ni(NO₃)₂.6H₂O. The quantities of each of these salts in solution were determined so as to deposit the desired quantity of each element in the catalyst.

After maturing at ambient temperature in a water-saturated atmosphere, the extrudates of the impregnated support were dried overnight at 120° C. then calcined at 500° C. for 2 hours in air. The molybdenum trioxide content was 16% by weight, that for nickel oxide was 3% by weight, and that for phosphorous pentoxide was 2.3% by weight. The atomic ratio P/Mo was equal to 0.29. Finally, the Ni/Mo atomic ratio was equal to 0.36.

### Example 9

### Preparation of a Catalyst B2 (In Accordance with the Invention)

We dry impregnated a support B obtained from Example 2 for which there was no macroporosity; its characteristics are indicated in Table 1. The aqueous impregnation solution contained molybdenum, nickel and vanadium salts as well as phosphoric acid (H₃PO₄) and hydrogen peroxide (H₂O₂). The molybdenum salt was ammonium heptamolybdate, Mo₇O₂₄(NH₄)₆.4H₂O and the nickel salt was nickel (cobalt) nitrate Ni(NO₃)₂.6H₂O. The vanadium was introduced using vanadium sulphate. The quantities of each of these salts in solution were determined so as to deposit the desired quantity of each element in the catalyst.

After maturing at ambient temperature in a water-saturated atmosphere, the extrudates of the impregnated support were dried overnight at 120° C. then calcined at 500° C. for 2 hours in air. The molybdenum trioxide content was 16% by weight, that for nickel oxide was 3% by weight, that for vanadium pentoxide was 3.9% by weight and that for phosphorous pentoxide was 5.0% by weight. The atomic ratio P/Mo was equal to 0.63. The Ni/Mo atomic ratio was equal to 0.36. Finally, the V/Mo ratio was equal to 0.39.

### Example 10

### Evaluation of Catalysts B1 and B2 Using Fixed Bed Hydrotreatment

Catalysts B1 and B2 described in Examples 8 and 9 were compared in a test for the hydrotreatment of oil residues with a downstream charge of catalyst A1 (30% of the catalytic volume, with 70% of the volume occupied by catalysts B1 or B2) which carried out hydrodemetallization, the ensemble making up the industrial hydrotreatment process assembly. The feed was constituted by a mixture of an atmospheric residue (AR) of Middle Eastern origin (Arabian Medium) and a vacuum residue (Arabian Light). This residue is characterized by high Conradson carbon residues (13.2% by weight) and asphaltenes (5.2% by weight) and a large quantity of nickel (22 ppm by weight), vanadium (67 ppm by weight) and sulphur (3.38% by weight). The complete characteristics of the feed are reported in Table 5.

TABLE 5
Characteristics of the AM/VR AL AR feed used

| | | AM/VR AL AR mix |
|---|---|---|
| Density 15/4 | | 0.9886 |
| Sulphur | % by wt | 3.86 |
| Nitrogen | ppm | 2800 |
| Nickel | ppm | 22 |
| Vanadium | ppm | 67 |
| Conradson carbon residue | % by wt | 13.2 |
| C7 asphaltenes | % by wt | 4.6 |
| Simulated distillation | | |
| IP | ° C. | 261 |
| 5% | ° C. | 362 |
| 10% | ° C. | 403 |
| 20% | ° C. | 454 |
| 30% | ° C. | 497 |
| 40% | ° C. | 536 |
| 50% | ° C. | 571 |
| 60% | ° C. | 603 |
| 70% | ° C. | — |
| 80% | ° C. | — |
| 90% | ° C. | — |
| SD: EP ° C. | ° C. | 614 |
| SD: distillation residue | % by wt | 63 |

Following a step for sulphurization by circulating a gas oil cut supplemented with DMDS at a final temperature of 350° C., the unit was operated with the oil residue described below under the operating conditions of Table 6.

TABLE 6
Operating conditions employed with fixed bed reactor

| | | |
|---|---|---|
| Total pressure | 15 | MPa |
| Test temperature | 370° | C. |
| Hourly space velocity of residue | 0.2 | h⁻¹ |

| | |
|---|---|
| Hydrogen flow rate | 1000 std L_{H2}/L_{feed} |

After a stabilization period of 300 hours, the hydrodesulphurization (HDS) and hydrodemetallization (HDM) performances were calculated, as well as that for hydroconversion of the VR (540° C.+ cut). They are recorded in Table 7.

TABLE 7
HDS, HDM and HDX performances of concatenations
of catalysts Aₓ + B_{y}

| Catalysts | HDS (%) | HDM (%) | HDX₅₄₀₊ (%) |
|---|---|---|---|
| A1 + B1 (comparative) | 92 | 85 | 12 |
| A1 + B2 (invention) | 92 | 84 | 17 |
| A2 + B1 (invention) | 92 | 85 | 19 |
| A2 + B2 (invention) | 91 | 84 | 22 |

It can be seen that the catalytic system of the invention performs much better in VR hydroconversion (+5%) than the conventional system, with no significant loss of HDS or HDM.

### Example 11

### Fixed Bed Hydrotreatment Evaluation of Catalytic Systems “A2+B1” and “A2+B2” Compared with the Catalytic System “A1+B1”

In order to validate the importance of the catalytic system constituted by a catalyst in accordance with the invention for hydrodemetallization, HDM, and a catalyst in accordance with the invention for hydrodesulphurization, HDS, the catalytic systems “A2+B 1” and “A2+B2” were evaluated using the test methodology described in Example 10 (same operating conditions and same proportions of catalysts). The results of the evaluations are shown in Table 7. It can be seen that using the process of the invention in which the vanadium-impregnated catalyst is positioned in the HDM section (A2) provides for an increase in conversion over the catalytic system as a whole with a conventional catalyst in the HDS section (+7%), and this increase can even be enhanced when using the complete system of the invention, i.e. with vanadium-impregnated catalysts in both steps (HDM and HDS): A2+B2. Furthermore, these gains are obtained without any significant drop over the catalytic system as a whole.

The entire disclosures of all applications, patents and publications, cited herein and of corresponding French Application No. 12/03467, filed Dec. 18, 2012 are incorporated by reference herein.

1. A catalyst for the hydrotreatment of heavy hydrocarbon feeds, comprising:
at least one element from group VIB;
at least one element from group VIII;
phosphorus in a quantity in the range 0.1% to 9% by weight of phosphorus pentoxide with respect to the total catalyst mass;
vanadium in a quantity in the range 0.25% to 7% by weight of vanadium pentoxide with respect to the total catalyst mass;
at least one porous refractory oxide support;
said catalyst having the following characteristics:
a total pore volume of 0.3 mL/g or more;
a macropore volume, defined as the volume of pores with a diameter of more than 50 nm, of 40% or less of the total pore volume;
a median diameter of the mesopores, defined as pores with a diameter in the range 3.6 to 50 nm, in the range 5 nm to 36 nm;
a BET surface area of at least 120 m²/g.

2. A catalyst according to claim 1, in which the vanadium content is in the range 0.5% to 5% by weight of vanadium pentoxide with respect to the total catalyst mass.

3. A catalyst according to claim 2, in which the vanadium content is in the range 0.6% to 4% by weight of vanadium pentoxide with respect to the total catalyst mass.

4. A catalyst according to claim 1, in which the quantity of metal from group VIB is in the range 2% to 20% by weight and the quantity of metal from group VIII is advantageously in the range 0.1% to 5% by weight, the contents being expressed as the % of metallic oxide with respect to the total catalyst mass.

5. A catalyst according to claim 1, in which the oxide support comprises alumina in the major proportion.

6. A catalyst according to claim 1, in which the element from group VIB is molybdenum.

7. A catalyst according to claim 1, in which the element from group VIII is nickel or cobalt.

8. A catalyst according to claim 1, in which atomic ratio of vanadium to metals from group VIB is in the range 0.1:1 to 0.5:1.

9. A catalyst according to claim 1, in the partially or completely sulphurized form.

10. A catalyst according to claim 1, in which the median diameter of the mesopores is in the range 5 to 20 nm, the total pore volume is 0.3 mL/g or more and the macropore volume is less than 10% of the total pore volume.

11. A catalyst according to claim 1, in which the median diameter of the mesopores is in the range 10 to 36 nm, the total pore volume is 0.5 mL/g or more and the macropore volume is more than 5% of the total pore volume.

12. A hydrotreatment process using at least one catalyst according to claim 1, for the hydrotreatment of heavy hydrocarbon feeds selected from atmospheric residues, vacuum residues obtained from straight run distillation, deasphalted oils, residues obtained from conversion processes such as, for example, those obtained from coking, from fixed bed hydroconversion, from ebullated bed hydroconversion or from moving bed hydroconversion, used alone or as a mixture.

13. A hydrotreatment process according to claim 12, carried out in part in an ebullated bed at a temperature in the range 320° C. to 450° C., at a partial pressure of hydrogen in the range 3 MPa to 30 MPa, at a space velocity which is advantageously in the range 0.1 to 10 volumes of feed per volume of catalyst per hour, and with a ratio of gaseous hydrogen to liquid hydrocarbon feed which is advantageously in the range 100 to 3000 normal cubic metres per cubic metre.

14. A hydrotreatment process according to claim 12, carried out at least in part in a fixed bed at a temperature in the range 320° C. to 450° C., at a partial pressure of hydrogen in the range 3 MPa to 30 MPa, at a space velocity which is advantageously in the range 0.05 to 5 volumes of feed per volume of catalyst per hour, and with a ratio of gaseous hydrogen to liquid hydrocarbon feed which is advantageously in the range 200 to 5000 normal cubic metres per cubic metre.

15. A fixed bed residue hydrotreatment process comprising at least:
a) a hydrodemetallization step;
b) a hydrodesulphurization step;
in which at least one catalyst according to claim 1 is used in at least one of said steps a) and b).
